(19) United States
(12) Patent Application Publication
(10) Pub. No.: US 2025/0137112 A1
(43) Pub. Date: May 1, 2025

(54) SYSTEMS AND METHODS FOR DEPOSITION-BASED MANUFACTURING AND MATERIAL SEPARATION IN SPACE ENVIRONMENTS

(71) Applicant: Trans Astronautica Corporation, Lake View Terrace, CA (US)

(72) Inventors: James G. Small, Sonoita, AZ (US); Joel C. Sercel, Lake View Terrace, CA (US); Craig E. Peterson, Los Angeles, CA (US); Philip J. Wahl, Altadena, CA (US)

(21) Appl. No.: 18/923,517

(22) Filed: Oct. 22, 2024

Related U.S. Application Data
(60) Provisional application No. 63/593,194, filed on Oct. 25, 2023.

(51) Int. Cl. C23C 4/123; B64G 99/00

(52) U.S. Cl. CPC C23C 4/123; B64G 99/00

(57) ABSTRACT

Systems and methods for deposition-based manufacturing and quantum spin separation in space environments are disclosed herein. A method of manufacturing a film in a space environment includes melting a metal in a melting pot using concentrated solar energy and pushing the melted metal through small openings in the melting pot to produce a liquid stream. The method further includes dispersing the liquid stream into liquid drops of the melted metal and depositing the liquid drops onto a mold surface.

### INCORPORATION BY REFERENCE TO ANY PRIORITY APPLICATIONS

This application is based upon and claims the benefit of priority from U.S. Provisional Patent Application No. 63/593,194 filed on Oct. 25, 2023. Moreover, any and all applications for which a foreign or domestic priority claim is identified in the Application Data Sheet as filed with the present application are hereby incorporated by reference under 37 CFR 1.57. The entire contents of each of the above-listed items is hereby incorporated into this document by reference and made a part of this specification for all purposes, for all that each contains.

### BACKGROUND

### Field

The present description relates to and discloses techniques for manufacturing and quantum spin separation in space environments.

### SUMMARY OF CERTAIN INVENTIVE ASPECTS

One aspect includes a method of manufacturing a film in a space environment, comprising: melting a metal in a melting pot using concentrated solar energy; pushing the melted metal through small openings in the melting pot to produce a liquid stream; dispersing the liquid stream into liquid drops of the melted metal; and depositing the liquid drops onto a mold surface.

In some embodiments, the method further comprises: providing an enclosure that encloses the melting pot and the mold surface; and providing a background gas within the enclosure at a pressure sufficient to maintain the liquid stream and the liquid drops in liquid form without boiling into vapor before the liquid drops are deposited onto the mold surface.

In some embodiments, the background gas is an inert gas.

In some embodiments, the dispersing the liquid stream into liquid drops is performed using a disruptor comprising: one or more rapidly vibrating openings, one or more rapidly rotating chopper blades, and/or a rapidly rotating wheel, and/or a compressed-gas spray nozzle.

Another aspect includes a device for space manufacturing comprising: a solar concentrator; an enclosure configured to use energy from the solar concentrator to melt metal; a dispenser configured to supply melted metal through small openings in the enclosure and produce a liquid stream of the melted metal; a disruptor configured to manipulate the stream of the melted metal and disrupt the flow, thereby dispersing the stream into liquid drops of the melted metal; and a mold having a surface configured to receive the dispersed liquid drops of the melted metal.

In some embodiments, a background gas is provided within the enclosure at a pressure sufficient to maintain the liquid stream of the melted metal and the liquid drops of the melted metal in liquid form without boiling into vapor before the liquid drops of the melted metal are deposited onto the mold surface.

In some embodiments, the background gas is an inert gas.

In some embodiments, the disruptor comprises: one or more rapidly vibrating openings, one or more rapidly rotating chopper blades, and/or a rapidly rotating wheel, and/or a compressed-gas spray nozzle.

Yet another aspect is a method of separating chemical elements in a space environment, comprising: melting the chemical elements in an enclosed oven to form a vapor; emitting the vapor from the oven and through a series of apertures to create a collimated stream of atoms; passing the collimated stream of atoms through a region of gradient magnetic field to separate the chemical elements; and collecting the separated chemical elements in separate containers.

In some embodiments, the method further comprises: providing concentrated solar energy to the oven to heat the oven to a first temperature sufficient to melt the chemical elements.

In some embodiments, the method further comprises: heating the series of apertures to a second temperature that is substantially equal to or above a third temperature of the melted chemical elements.

In some embodiments, the method further comprises: returning uncollimated atoms back to the melt chemical elements using the series of apertures.

In some embodiments, the series of apertures are shaped as slits.

In some embodiments, the method further comprises: rotating the oven to cause the melted chemical elements to be pressed against inner surfaces of the oven.

Still yet another aspect is a space chemical separation apparatus comprising: an oven having an enclosure configured to melt chemical elements and hold an associated vapor; an oven egress comprising at least two apertures arranged in a series to create a collimated stream of atoms from the vapor; a magnet configured to create a gradient magnetic field positioned to control the collimated stream of atoms, separating chemical elements therefrom; and at least two containers configured to receive at least two different chemical elements after separation.

In some embodiments, the apparatus further comprises: a solar concentrator configured to concentrate solar energy and provide the concentrated solar energy to the oven to heat the oven to a first temperature sufficient to melt the chemical elements.

In some embodiments, the solar concentrator is further configured to heat the at least two apertures to a second temperature that is substantially equal to or above a third temperature of the melted chemical elements.

In some embodiments, the at least two apertures are further configured to return uncollimated atoms back to the melt chemical elements.

In some embodiments, the at least two apertures are shaped as slits.

In some embodiments, the oven is further configured to rotate to cause the melted chemical elements to be pressed against inner surfaces of the oven.

In some embodiments, the apparatus further comprises: a spray nozzle configured to form a stream of liquid drops from the melted chemical elements, wherein the magnet is further configured to separate elements from the stream of liquid drops.

### BRIEF DESCRIPTION OF THE DRAWINGS

In the following figures, like number labels refer to like components in all figures.

FIG. 1 illustrates a space-based fractional distillation facility

FIG. 2 illustrates a step in the manufacturing roadmap which can be performed using a sintering system.

FIG. 3 illustrates a step in the roadmap which can be implemented by a system for fabricating structural rods and channel beams by melt extrusion.

FIG. 4 illustrates a step in which the glassy melt can extruded into thin fibers using a system for fabricating fine fibers by melt extrusion.

FIG. 5 illustrates a method for using concentrated solar energy to melt and vaporize a feedstock material which can be used for Heliofab additive manufacturing techniques in accordance with aspects of this disclosure.

FIG. 6 illustrates a system that can be used for quantum spin separation (QSS) in accordance with aspects of this disclosure.

FIG. 7 summarizes the mean-free-path vs pressure for Nitrogen molecules.

FIG. 8 illustrates a system for providing concentrated solar energy for uniformly heating a rotating oven in accordance with aspects of this disclosure.

FIG. 9 provides a detailed internal view of the rotating oven with collimating exit apertures in accordance with aspects of this disclosure.

FIG. 10 is a flowchart of an example method of manufacturing a film in a space environment in accordance with aspects of this disclosure.

FIG. 11 is a flowchart of an example method of separating chemical elements in a space environment in accordance with aspects of this disclosure.

### DETAILED DESCRIPTION

Aspect of this disclosure relate to systems and methods for fabricating materials and structural members on orbit, which can then be used for constructing large orbiting space platforms. In some embodiments, feedstock materials can be processed from asteroid and lunar regolith sources. Solar energy, hard vacuum, and low temperature of deep space can be used in manufacturing processes.

Aspects of this disclosure relate to multiple methods to move large-scale manufacturing processes that may have been implemented on Earth into the region of near-Earth space and beyond. Such systems may be referred to herein as “AstraForge.” Advantageously, space-based manufacturing can make use of environmental assets that are not easily duplicated on Earth. Notable among these space assets are: uninterruptable solar energy that is useful for both electric power and process heating; micro gravity; unlimited hard vacuum; and the very low temperature of deep space that may be used for temperature control and cooling of various manufacturing processes.

While near-Earth space appears from casual observations to be largely empty, it is in fact a rich source of raw materials that can be collected and processed into feedstocks for many useful manufactured products. Harvesting spent and burned-out satellites provides a source of metals, volatile hydrocarbons, and optical and electronically useful chemical elements. A further incentive to harvest dead spacecraft is the environmentally beneficial result of cleaning up space junk. Additional raw materials in the form of mineral regolith are available on or below the surface of the Moon.

Relatively small asteroids frequently pass near Earth. It is often possible to intercept and capture material from asteroids using less energy and rocket propellant than is required to lift a similar mass of material from the surface of the Moon. Many thousands of tons of asteroid material pass close to the Earth-Moon cis-lunar space each year. The alternative of lifting a large mass to orbit from the deep gravity-well of the Earth is not cost effective.

The value of certain materials in space may be substantially different from their value on Earth. Volatile hydrocarbons and water are of considerable interest. Water has uses for life support, for rocket fuel in oxy-hydrogen chemical rockets, and as a non-combustible propellant for solar thermal rockets. Therefore, aspects of this disclosure provide methods for the relatively low-temperature recovery of water and hydrocarbons from mixed feedstocks to high-temperature separation of metals and refractory oxides.

Many manufacturing methods require prodigious amounts of process heat. For terrestrial applications, heat is usually generated from combustion of fossil fuels, such as natural gas, or from electric heating by plasma arc discharge or direct induction of large electrical currents. In near-Earth space, one abundant energy source that can be employed is solar energy.

Physical laws dictate that the theoretical maximum temperature achievable by an ideal solar concentrator is the surface temperature of the Sun (5778 K). Ray trace analyses and ground tests with meter-class inflatable optics show that fabricated thin film reflectors can produce peak temperatures of over 2800 K, enough to melt and then vaporize aluminum, magnesium, and other known spacecraft and asteroid constituents. Analysis has shown that reflector diameters on the scale of hundreds of meters are capable of vaporizing metric tons of iron in the timeframe of days.

Aspects of this disclosure use lightweight solar collectors to provide megawatts of continuous process heat for six types of manufacturing processes. The manufacturing roadmap includes: 1) fractional distillation of volatile materials ranging from the separation of relatively low-temperature water vapor and hydrocarbons to the separation of high-temperature melted and vaporized metals. 2) Sintering of low strength ceramics. 3) Direct melting and extrusion of rocky materials into rigid rods and shaped extrusions for use as structural components. 4) Extrusion of melt into submillimeter diameter flexible fiber products. 5) Heliofab additive manufacturing in microgravity. 6) High purity separation of various chemical elements including common metals, rare earths, and semiconducting elements using the method of Quantum Spin Separation.

### Fractional Distillation of Volatile Materials

Fractional distillation is commercially implemented at industrial scale in large chemical engineering facilities on Earth. Fractional distillation typically involves vaporizing a complex mixture and then separately condensing various constituents at progressively lower temperatures. The method exploits differences in the condensation temperatures of vapor constituents. For example, tall distillation towers are a prominent fixture of oil refineries. Aspects of this disclosure involve modifying and adapting these principles to take advantage of space resources.

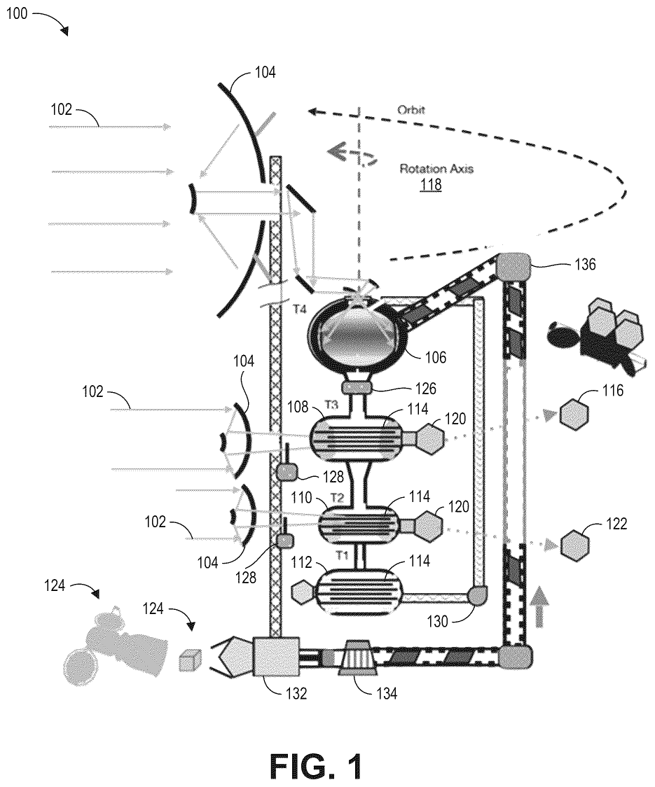

FIG. 1 illustrates a space-based fractional distillation facility 100. The distillation factory 100 includes a plurality of collecting reflectors 104, a plurality of pressure chambers 106, 108, 110, and 112, a spin motor 126, a plurality of shutters 128, a pump 130 for carrier gas, a feedstock shredder 132, a rotating hopper 134, and an auger system 136. Incoming solar energy 102 is concentrated by large collecting reflectors 104 and directed into a pressure chamber 106 where the solar energy 102 heats the pressure chamber 106 to a temperature T4. Various feedstock materials are heated to release volatile constituents. An inert carrier gas, such as Argon or Nitrogen, entrains the volatile vapors and circulates from the high temperature T4 chamber through lower temperature T3, T2 and T1 condensation chambers 108, 110, and 112. Secondary collecting reflectors 104 can be provided to collect and concentrate solar energy 102 for temperature control of the condensation chambers 108 and 110. The carrier gas is then reinjected back into the T4 chamber 106. Volatile vapors condense preferentially and sequentially on condensation plates 114 whose temperature is controlled to be below their condensation or freezing temperature. The resulting condensed liquids may be delivered 116 to other users or used directly as propellants in solar thermal rockets.

The chambers 106-112 can be arranged as a fractional distillation column configured to rotate about a central axis 118. Volatile vapors can be separately collected in the chambers 106-112 according to their condensation temperatures.

Rotation of the vaporization and condensation chambers 106-112 about the common axis 118 serves to sweep solids and condensed purified liquids into collection containers 120. The central axis 118 of rotation contains only gaseous vapors. When the containers 120 are filled, they can be disconnected and moved for export 116 to other manufacturing processes 122. Continuous processing is possible by adding feedstock materials to chamber 106 using the auger system 136 designed to work in microgravity conditions. Periodically, operation may be interrupted for cleaning and removal of unwanted soot and slag deposits.

In some embodiments, fractional distillation can have two separate temperature regions. Water and volatile hydrocarbons may be vaporized and condensed at temperatures generally below 150 C. After low temperature volatiles have been removed, the remaining solid material may be used as feedstock for high temperature distillation or for sintering into ceramics.

Feedstocks 124 such as reclaimed or burned-out spacecraft and other man-made space junk contain large quantities of reduced metals. Aluminum, copper, tin, and gold are prominent components of spacecraft. These metals can be melted and vaporized at temperatures generally between 800 C and 2000 C. In a microgravity environment, fractional distillation of metals may proceed in similar fashion to distillation of lower temperature volatiles.

With massive spinning objects in a micro gravity factory 100, it can be desirable to control the total angular momentum of the structure. Here the axis 118 of the spinning distillation tower is carefully aligned substantially parallel to the axis of spacecraft rotation in inertial space. Not shown is a counter-rotating compensation mass configured to spin about the same axis or a parallel axis.

During motion along its orbit, the factory 100 is configured to slowly rotate to keep its solar collectors 104 aligned with the sun. Rotation of internal machinery about any other axis may cause relatively large gyroscopic precession forces on the rotating parts. Large rotating masses can produce potentially damaging torques on support bearings and connected piping. Precession forces can also cause the entire factory 100 to rotate out of alignment with the sun. Rotation of machinery about the primary axis puts minimal forces on bearings. Differential rotation of the distillation tower and its compensating inertial mass can be used to keep the large collecting mirrors 104 always pointed at the sun without need of pointing gimbals on the mirrors 104.

### Sintering of Low-Strength Ceramics

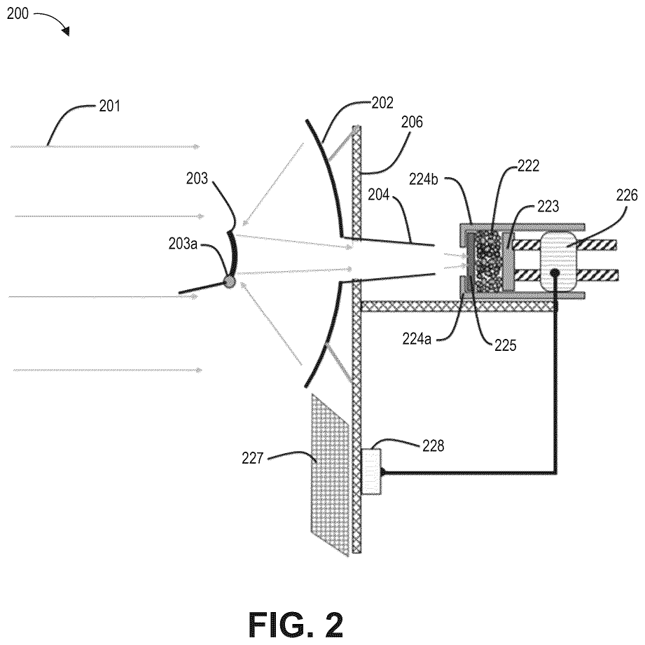

FIG. 2 illustrates Step 2 in the manufacturing roadmap which can be performed using a sintering system 200. The sintering system 200 includes a mirror 202, a secondary mirror 203, an adjustable shutter 203a, a light conduit 204, a structure 206, jaws 223, 224a, and 224b, an electrically powered vice 226 including a heated pusher plate 225, a photoelectric solar panel 227, and an electrical controller 228. Feedstock solids are first ground to powders 222. The powders 222 are subjected to uniaxial compression and vacuum-sintered to produce low-performance ceramic plates and blocks. The loose powder 222 can fill a shaped volume between the jaws 223, 224a, and 224b and heated by the pusher plate 225 of the electrically powered vice 226. The method may be similar to terrestrial manufacture of bricks and fired ceramics. Sintering temperatures may range from 900 C to 1800 C depending on the suitability of the feedstock. Asteroid feedstock will generally not be optimal for manufacturing high-strength ceramics. However, there are many useful applications for low strength ceramics in the microgravity environment of space structures. These include bricks for bulk mass shielding as radiation protection of manned structures and tiles for sacrificial heat shields for re-entry vehicles.

As illustrated in FIG. 2, the powdered feedstock 222 can be heated by concentrated solar energy to sintering temperatures from approximately 900 C to 1800 C. Uni-axial compression causes the powder 222 to sinter into low strength ceramics with relatively low density. At higher temperatures, the feedstock 222 can be melted into high density glassy bricks.

### Direct Melting and Extrusion of Rocky Feedstocks

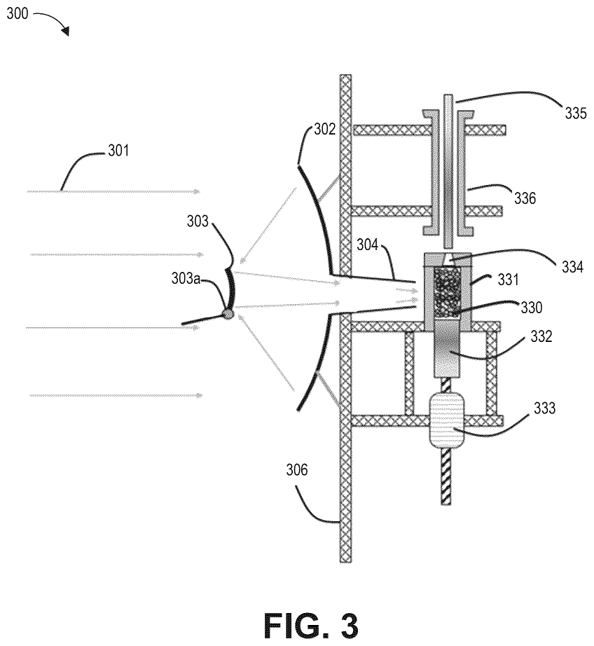

FIG. 3 illustrates Step 3 in the roadmap which can be implemented by a system 300 for fabricating structural rods and channel beams by melt extrusion in accordance with aspects of this disclosure. The system 300 includes a mirror 302, a secondary mirror 303, an adjustable shutter 303a, a light conduit 304, a structure 306, a hollow cylinder 331, a piston 332, an electric motor 333, a shaped exit orifice 334, and one or more guides 336. Here a solar heated furnace completely melts the feedstock 330 to a glassy consistency. The melt is extruded and cooled to form low-performance structural shapes 335 like rods, I-beams, and channels. The glassy structures can be slowly cooled to allow the glass to anneal. Generally glassy extrusions can be held at a constant temperature of 400 C for several hours before final cooling. Thus, nonvolatile feedstock 330 can be melted and extruded into useful construction shapes 335.

Extrusion of Melt into Flexible Fiber Products.

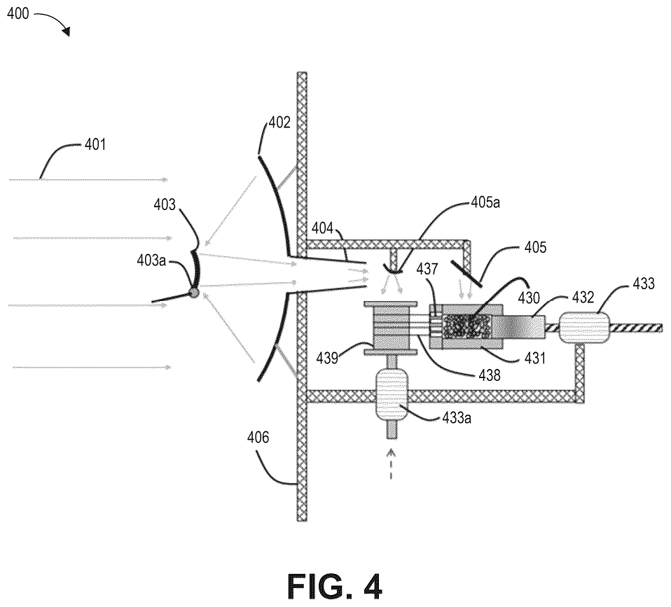

FIG. 4 illustrates step 4 in which the glassy melt can extruded into thin fibers using a system 400 for fabricating fine fibers 438 by melt extrusion in accordance with aspects of this disclosure. The system includes a mirror 402, a secondary mirror 403, an adjustable shutter 403a, a light conduit 404, additional mirrors 405 and 405a, a structure 406, a hollow cylinder 431, a piston 432, electric motors 433 and 433a, one or more openings 437, and a rotating drum 439. Also known as mineral wool, fibers made from various sources of terrestrial rock have been available as commercial products since 1897. They are still used today for non-combustible thermal insulation. Melted rocky feedstock 430 can be extruded into thin flexible glassy fibers 438. Like most glassy products, the fibers 438 can be annealed for several hours at approximately 400C.

In many space applications, the mechanical forces on very large structures may remain relatively low due to the microgravity environment. Therefore, many large structures may be constructed from materials of relatively low mechanical strength that would not be feasible on Earth. Mineral fibers 438 are not as strong as engineered glass fibers, but they may still be twisted into threads, cords, and ropes for use as low-performance tension members in large microgravity constructions. Alternately, fibers 438 may be woven into low-performance fabrics. As usual with glassy materials, the fibers 438 can be annealed at a constant temperature of approximately 400 C for several hours before they can be used in ropes and fabrics.

### Heliofab Additive Manufacturing in Microgravity

Traditional fabrication methods produce complex objects through milling, machining, carving, shaping or other means that remove material from a starting work piece. By contrast, additive manufacturing (AM) builds up complex objects by adding material, usually layer by layer, in precise geometric shapes usually controlled by a computer and often referred to as “3D printing”. The physical size of the finished product is limited by the size of the 3D printer.

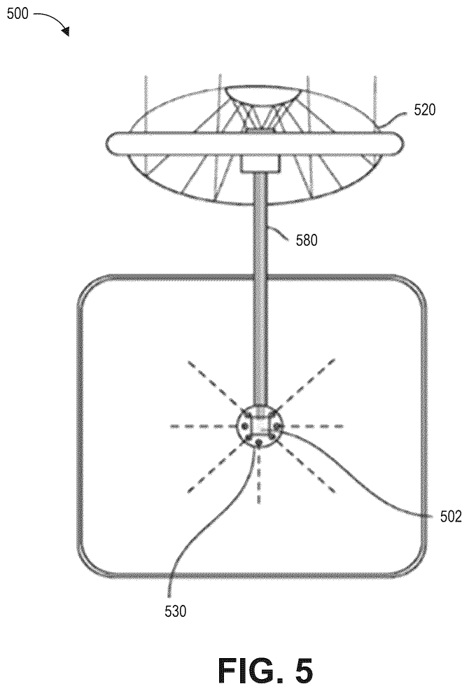

The microgravity and hard vacuum environment of space-based manufacturing may be used to produce a class of AM objects that are much larger than the physical size of the material dispenser or “printing head”. For example, relatively large structures such as storage tanks may be constructed as a single part without seams or joints. FIG. 5 illustrates a method for using concentrated solar energy to melt and vaporize a feedstock material, usually a metal, which can be used for Heliofab additive manufacturing techniques in accordance with aspects of this disclosure. For example, the Heliofab technique can involve spraying liquid metal droplets upon a complex molding surface to build up thick metal structures. The system 500 includes a solar concentrator 520, a light tube 580 (a hollow tube with a reflective inner surface and transparent ceramic end window), a thin foil 502 (e.g., a mold), and feedstock material 530. The vapors pass through a region of hard vacuum and then attach to the surface of the prepositioned thin foil shape 502.

The Heliofab methods described herein differ from other manufacturing techniques such as the physical vapor deposition (PVD) process and from a related method aerosol deposition (AD) process. PVD and AD can be used to prepare high performance thin film coatings for many industrial applications including semiconductor fabrication, food packaging, and surface hardening of machine tools.

PVD uses various methods of vaporization, such as sputtering, electron beam bombardment, or thermal evaporation, to produce a dilute vapor of individual atoms or discrete molecules. The resulting atomic or molecular vapors are propelled through a region of hard vacuum to impact a suitable substrate surface. Atoms (usually metals) are deposited layer after layer in a nearly perfect single crystal film, which is used for most semiconductor fabrication. Films created by this process have high internal stress. As the layers thicken, the film stress increases resulting in eventual rupture or cracking of the film. If the film is formed too thick, the film curls up and peels away from the substrate. PVD is typically unable to produce films thicker than about 10 microns.

AD can be used to produce thin films from refractory (high melting temperature) ceramic materials such as Al₂O₃. In this process micro crystals of the film material are accelerated toward the receiving surface by a small gas-powered rocket nozzle. The energy of impact melts the incoming micro crystals which then fuse to previously deposited material and immediately refreeze. By this process refractory films may be deposited on suitable substrates without excessively heating the substrate. Like PVD, the AD process produces fused films with internal stress. AD films are rarely thicker than 50 microns.

The Heliofab methods described herein can be used to enhance or improve on other techniques (e.g., PVD and/or AD techniques). For example, the disclosed Heliofab methods can disperse, in a vacuum or low pressure gas, liquid drops of molten metal instead of atoms or high-speed solid aerosol particles. The drops flash freeze when they reach the mold surface. The resulting deposit can include multi-crystalline dots or spots rather than a single-crystal film, thereby avoiding excessive film stress. The resulting film density is not as high as PVD or AD processes, but very thick films may be achieved.

In the Heliofab method, a feedstock metal (or other chemical compound feedstock) is melted with concentrated solar energy. The liquid melt is then pushed through small openings in the melting pot by using a forcing piston or by centrifugal force from a rapidly spinning pot. The mechanism used for pushing the liquid melt through the small openings may be referred to as a “dispenser” herein. The thin liquid streams may be broken into droplets by several mechanisms, which may collectively be referred to as “disruptors”: 1) rapidly vibrating openings, 2) rapidly rotating chopper blades, 3) by impacting the outer edge of a rapidly rotating wheel, or 4) by mixing the melted liquid with compressed gas to form a spray nozzle which accelerates the streams, tearing them into droplets and flinging them outwards toward the molding shell.

In some embodiments, it can be advantageous to provide a pressurized gas in order to aid in forming the droplets. For example, for certain materials (e.g., water or some metals) it can be difficult to form droplets in a hard vacuum as many materials may transition directly from a solid to a gas in hard vacuum. Thus, in some embodiments the Heliofab system can provide a pressurized gas (also referred to as a background gas) through which the liquid feedstock may be fed to aid in transitioning the melted feedstock into a liquid which can then be broken into droplets using the disruptor. It can be advantageous to use an inert gas as the background gas within the enclosure at a pressure sufficient to sustain the melted material in liquid form without boiling into vapor before the drops can impact and freeze to the surface of the mold.

### High Purity Quantum Spin Separation (QSS) of Chemical Elements

Aspects of this disclosure relate to QSS, which builds on the demonstrated principles of the Stern-Gerlach demonstration at Frankfurt University, Germany, in 1922. At that time, quantum mechanics was a new theory of Physics. The Stern-Gerlach experiment was the first demonstration of quantum effects in a macroscopic system. The experiment was quickly verified by other researchers using a variety of individual chemical elements. The principle has remained as a foundational demonstration of quantum mechanics for the past 100 years. There has been no industrial application of the process.

QSS extends this proven principle to the practical separation of a mixture of chemical elements into separate purified streams for industrial purposes. In the QSS process, a mixed stream of neutral atoms is emitted at thermal velocities from a heated oven in vacuum. The stream of atoms next passes through a vacuum drift region containing a gradient magnetic field. Chemical elements are deflected from straight-line flight based on their various intrinsic spin magnetic moments.

Unlike conventional mass spectrometry, in QSS it is not necessary to ionize and accelerate individual atoms. Conventional mass spectrometry was the process used by the Manhattan Project during World War II at Oak Ridge, TN, to separate nuclear isotopes of Uranium for use in the first atomic bombs. Like conventional mass spectrometry, QSS has the precision to separate streams of atoms down to the isotope level, but for most industrial purposes separation into separate chemical streams is sufficient accuracy.

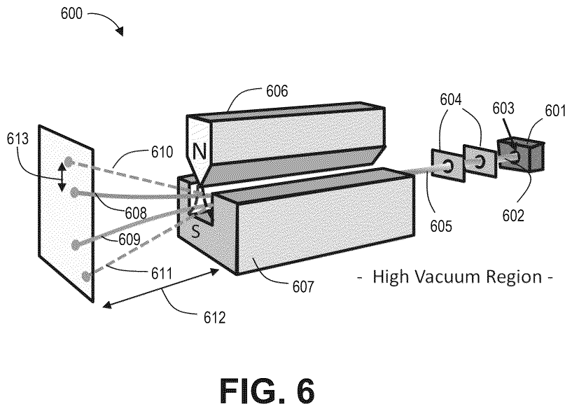

FIG. 6 illustrates a system 600 that can be used for QSS in accordance with aspects of this disclosure. The system 600 includes an oven 601 having a hole 3, a series of apertures 4, and shaped permanent magnets 6 and 7. Referring to FIG. 6, in QSS, a mixture of chemical elements is melted with applied heat and partially vaporized in the enclosed oven 601. Various atoms 602 from the vapor are allowed to escape from the oven through the hole 603 and the series of apertures 604. The collimated stream of atoms 605 proceeds in a straight line through a drift region of relatively high vacuum.

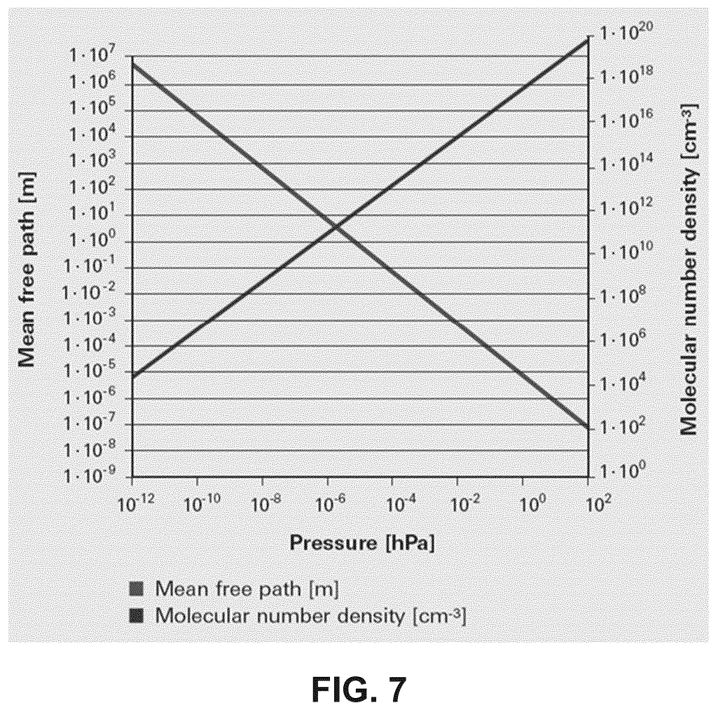

To properly separate the atoms 602, the pressure of residual background gas is sufficiently low that the vaporized atoms 602 are unlikely to suffer a collision during their flight through the system 600. In addition, the mean-free-path between collisions is longer than the size of the system 600 to ensure (or increase the likelihood) that the atoms 602 can be separated. FIG. 7 summarizes the mean-free-path vs pressure for Nitrogen molecules. For example, for a drift region of 10 meters, the pressure is less than approximately 10⁻⁷ hPa^{[6]}. This vacuum is well within the range of mechanical turbo pumps which can achieve vacuums down to 10⁻¹¹ hPa. The required vacuum is comparable to the vacuum environment of spacecraft in Mid-altitude Earth orbits (MEO), for example altitudes above 1000 km.

Referring again to FIG. 6, the collimated stream of atoms 605 is directed through a region of gradient magnetic field established by the specially shaped permanent magnets 606 and 607. A typical length for these magnets is 1 m. Longer magnets will result in increased angular separation of the chemical elements. For example, a magnetic gradient system 2 m long will produce four times the deflection angle.

Atoms 605 are deflected from straight-line flight in proportion to: the strength of an applied magnetic field gradient; the intrinsic spin angular momentum of each atom; and inversely proportional to their mass. As illustrated in FIG. 6, atoms 605 from a specific chemical element may be deflected either upwards 608 or downwards 609 but only though a specific angle. The split into precisely two deflection angles is a consequence of quantum mechanical processes. It is convincing proof of the accuracy of the quantum predictions.

Many elements have similar or equal spin angular momenta but substantially different masses. For example, copper Cu, silver Ag, and gold Au are all found in the same vertical column of the Periodic Table of Elements. They have nearly identical spin angular momentum. However, their masses are substantially different. Copper Cu has about half the mass of silver Ag. It will experience twice the deflection. Gold Au has about twice the mass of silver Ag and will experience half the deflection angle of silver Ag. Other elements have a wide range of values for spin angular momentum and for atomic mass. Estimates indicate that approximately 75% of all elements in the Periodic Table of Elements can be separated into discrete streams. This includes rare earth elements that may have high economic value or strategic importance.

After passing through the region of gradient magnetic fields, the separately deflected streams of chemical elements, for example Ag and Au, are allowed to drift through an additional distance shown by arrow 612. For a drift distance of 10 m indicated by arrow 612, the separation distance between streams will be approximately 10 cm as indicated by arrow 613. The separated streams may be collected as solid deposits in containers (not shown) where the temperature of each container is substantially below the freezing temperature of the elements.

The described QSS process is advantageous for space applications. For example, aspects of the described QSS process can include using only process-heat that can be obtained from solar thermal collector mirrors. The magnetic field gradient is readily available from rare earth permanent magnets. At MEO satellite orbiting altitudes, the low-pressure ambient space vacuum is more than sufficient for drift distances on the order of 10 m.

Advantageously, the QSS process described herein can be used to separate elements without complex chemical processing. One limit to efficiency lies in developing evaporating ovens that produce reasonably collimated atomic beams while efficiently recycling uncollimated atoms back into the feedstock melt.

In some embodiments, the system 600 can include a source of atoms 602 other than the oven 601. For example, the atoms 602 can be spalled directly from an asteroid, and separated using the specially shaped permanent magnets 606 and 607. The system 600 can also be used for separating a stream of liquid drops, such as the liquid metal drops created by the system 500 of FIG. 5 and/or melted and spalled directly from an asteroid. In some embodiments, the oven 601 can be configured to melt a material and the melted liquid can be combined with compressed gas to form a spray nozzle. The spray nozzle can be used to form a stream of liquid drops, which can be separated using the specially shaped permanent magnets 606 and 607 for collection.

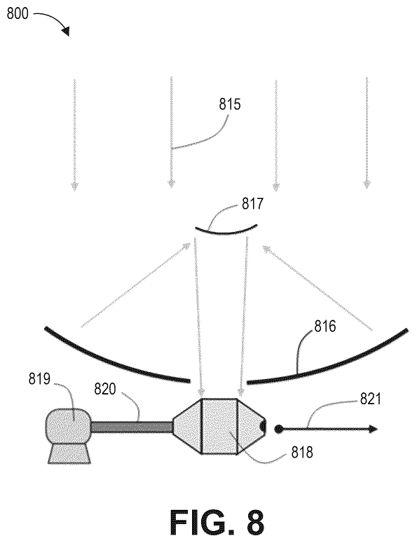

FIG. 8 illustrates a system 800 for providing concentrated solar energy for uniformly heating a rotating oven in accordance with aspects of this disclosure. The system 800 includes a primary collector mirror 816, a secondary mirror 817, a hollow rotating oven 818, an electric motor 819, and a thermally insulating rotating shaft 820. Referring to FIG. 8, incoming solar radiation 815 from the Sun is concentrated by primary collector mirror 816 and secondary mirror 817. Together, the primary collector mirror 816 and the secondary mirror 817 can form a solar concentrator. The concentrated solar energy impinges upon the outside of a hollow rotating oven 818 causing the oven 818 to come to a high temperature. The oven 818 forms an enclosure that can melt chemical elements when heated with the concentrated solar energy. An electric motor 819 connects to the oven 818 by means of a thermally insulating rotating shaft 820. Insulating shaft 820 prevents the motor 819 from overheating.

The oven 818 may contain a melted mixture of various chemical elements that have been derived from recycled space junk or lunar or asteroid material. The oven 818 emits a collimated stream of atoms indicated by arrow 821 into a region of hard vacuum. The stream of atoms is propelled out of the oven by thermal energy from the melted and vaporizing mixture. A typical atom velocity might be 300 m/s which is approximately the speed of sound in a hot gas.

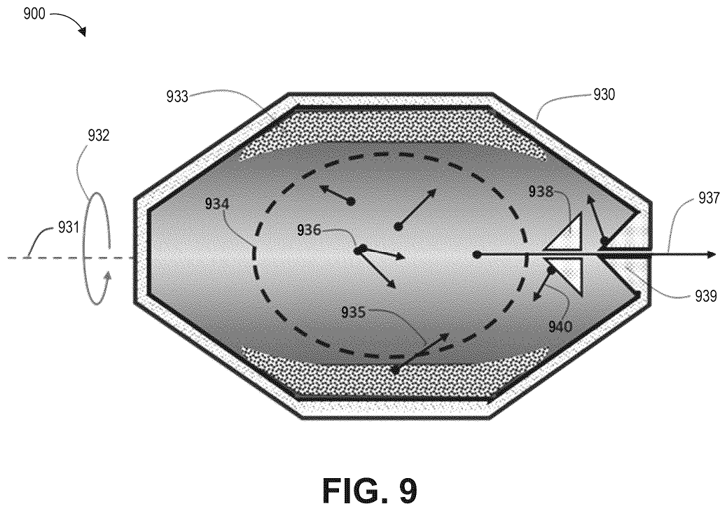

FIG. 9 provides a detailed internal view of the rotating oven 900 with collimating exit apertures in accordance with aspects of this disclosure. The oven 900 includes walls 930 and collimating apertures 938 and 939. Referring to FIG. 9, a motor (not shown) causes the outer shell 930 of the oven 900 to rotate about an axis 931 in the direction of curved arrow 932. Rotation causes the melted feedstock material 933 to be lightly pressed against the inner surfaces of the oven 900. A cloud of gaseous vapors from the melt 933 fills the middle region of the oven around the spin axis as indicated by broken ellipse 934. Individual atoms may evaporate from the melt 933 as shown by arrow 935. Atoms in the vapor cloud may collide with each other as shown by arrows 936. Other atoms in the cloud (not illustrated) may strike the chamber walls or be reabsorbed back into the melt. Some atoms 937 will have exactly the direction-of-flight needed to exit the oven through collimating apertures 938 and 939.

Because the oven 900 is heated from the outside, the temperature of the oven walls 930 will be equal to or slightly higher than the temperature of the melt 933. Melt 933 is slightly cooled by evaporation of its atoms 935. Any atoms which impact the internal surface of the oven wall 930 are quickly evaporated back to the vapor cloud 934 or returned to the melt 933. Collimating apertures 938 and 939 are, likewise, maintained at a temperature equal to or slightly higher than the melt temperature. Any atoms which strike the collimating apertures, as indicated by arrow 940, will likewise evaporate and be returned to the melt 933.

An oven with collimating apertures 938 and 939, which apertures 938 and 939 are held at a temperature at or above the temperature of the melt 933, will efficiently redirect non-collimated atoms back into the melt 933. By this means, the oven 900 can emit a stream of highly collimated atoms while efficiently recycling non-collimated atoms back into the feedstock melt 933.

In some embodiments, the apertures 938 and 939 can be shaped as slits or round holes. For example, for certain applications it may be advantageous for the apertures 938 and 939 to be shaped as slits to provide increased throughput compared to round holes.

### EXAMPLE METHODS

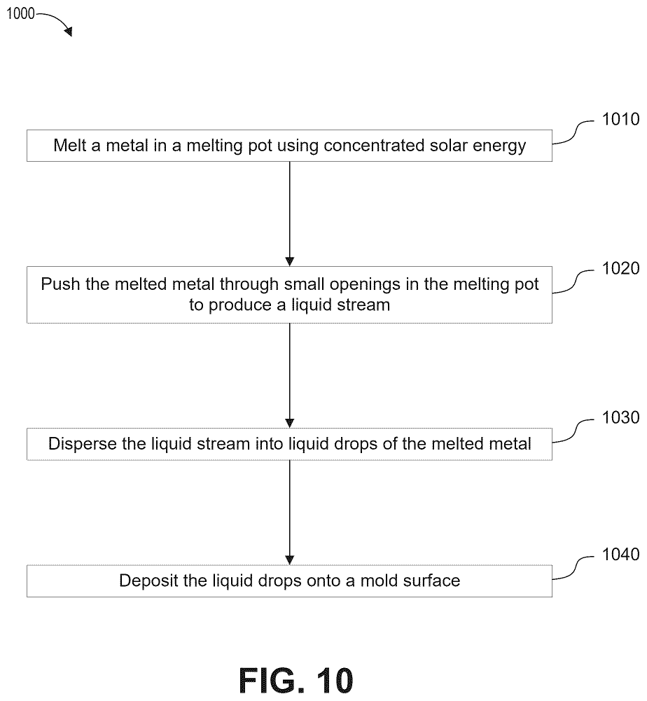

FIG. 10 is a flowchart of an example method 1000 of manufacturing a film in a space environment in accordance with aspects of this disclosure.

At step 1010, the method 1000 involves melting a metal in a melting pot using concentrated solar energy.

At step 1020, the method 1000 involves pushing the melted metal through small openings in the melting pot to produce a liquid stream.

At step 1030, the method 1000 involves dispersing the liquid stream into liquid drops of the melted metal.

At step 1040, the method 1000 involves depositing the liquid drops onto a mold surface.

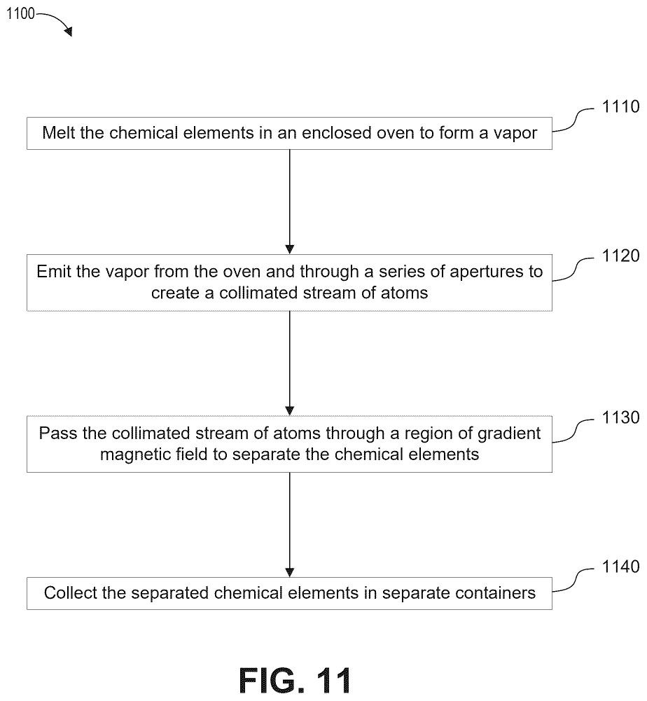

FIG. 11 is a flowchart of an example method 1100 of separating chemical elements in a space environment in accordance with aspects of this disclosure.

At step 1110, the method 1100 involves melting the chemical elements in an enclosed oven to form a vapor.

At step 1120, the method 1100 involves emitting the vapor from the oven and through a series of apertures to create a collimated stream of atoms.

At step 1130, the method 1100 involves passing the collimated stream of atoms through a region of gradient magnetic field to separate the chemical elements.

At step 1140, the method 1100 involves collecting the separated chemical elements in separate containers.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “can,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

The above detailed description is not intended to be exhaustive or to limit the invention to the precise form disclosed above. While specific embodiments of, and examples are described above for illustrative purposes, various equivalent modifications are possible within the scope of the disclosed invention(s), as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings provided herein can be applied to other systems, not necessarily the system described above. The elements and acts of the various embodiments described above can be extracted, subdivided, and/or combined to provide further embodiments.

While certain embodiments have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

Reference throughout this specification to “some embodiments” or “an embodiment” means that a particular feature, structure or characteristic described in connection with the embodiment is included in at least some embodiments. Thus, appearances of the phrases “in some embodiments” or “in an embodiment” in various places throughout this specification are not necessarily all referring to the same embodiment and may refer to one or more of the same or different embodiments. Furthermore, the particular features, structures or characteristics can be combined in any suitable manner, as would be apparent to one of ordinary skill in the art from this disclosure, in one or more embodiments.

As used in this application, the terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Similarly, it should be appreciated that in the above description of embodiments, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that any claim require more features than are expressly recited in that claim. Rather, inventive aspects lie in a combination of fewer than all features of any single foregoing disclosed embodiment.

Embodiments of the disclosed systems and methods can be used and/or implemented with local and/or remote devices, components, and/or modules. The term “remote” may include devices, components, and/or modules not stored locally. Thus, a remote device may include a device which is physically located in the same general area and connected via a device such as a switch or a local area network. In other situations, a remote device may also be located in a separate geographic area, such as, for example, in a different location, building, valley, and so forth.

A number of applications, publications, and external documents may be incorporated by reference herein. Any conflict or contradiction between a statement in the body text of this specification and a statement in any of the incorporated documents is to be resolved in favor of the statement in the body text.

Although described in the illustrative context of certain preferred embodiments and examples, it will be understood by those skilled in the art that the disclosure extends beyond the specifically described embodiments to other alternative embodiments and/or uses and obvious modifications and equivalents. Thus, it is intended that the scope of the claims which follow should not be limited by the particular embodiments described above.

What is claimed is:

1. A method of manufacturing a film in a space environment, comprising:
melting a metal in a melting pot using concentrated solar energy;
pushing the melted metal through small openings in the melting pot to produce a liquid stream;
dispersing the liquid stream into liquid drops of the melted metal; and
depositing the liquid drops onto a mold surface.

2. The method of claim 1, further comprising:
providing an enclosure that encloses the melting pot and the mold surface; and
providing a background gas within the enclosure at a pressure sufficient to maintain the liquid stream and the liquid drops in liquid form without boiling into vapor before the liquid drops are deposited onto the mold surface.

3. The method of claim 2, wherein the background gas is an inert gas.

4. The method of claim 1, wherein the dispersing the liquid stream into liquid drops is performed using a disruptor comprising: one or more rapidly vibrating openings, one or more rapidly rotating chopper blades, a rapidly rotating wheel, and/or a compressed-gas spray nozzle.

5. A device for space manufacturing comprising:
a solar concentrator;
an enclosure configured to use energy from the solar concentrator to melt metal;
a dispenser configured to supply melted metal through small openings in the enclosure and produce a liquid stream of the melted metal;
a disruptor configured to manipulate the stream of the melted metal and disrupt the flow, thereby dispersing the stream into liquid drops of the melted metal; and
a mold having a surface configured to receive the dispersed liquid drops of the melted metal.

6. The device of claim 5, wherein a background gas is provided within the enclosure at a pressure sufficient to maintain the liquid stream of the melted metal and the liquid drops of the melted metal in liquid form without boiling into vapor before the liquid drops of the melted metal are deposited onto the mold surface.

7. The device of claim 6, wherein the background gas is an inert gas.

8. The device of claim 5, wherein the disruptor comprises: one or more rapidly vibrating openings, one or more rapidly rotating chopper blades, a rapidly rotating wheel, and/or a compressed-gas spray nozzle.

9. A method of separating chemical elements in a space environment, comprising:
melting the chemical elements in an enclosed oven to form a vapor;
emitting the vapor from the oven and through a series of apertures to create a collimated stream of atoms;
passing the collimated stream of atoms through a region of gradient magnetic field to separate the chemical elements; and
collecting the separated chemical elements in separate containers.

10. The method of claim 9, further comprising:
providing concentrated solar energy to the oven to heat the oven to a first temperature sufficient to melt the chemical elements.

11. The method of claim 10, further comprising:
heating the series of apertures to a second temperature that is substantially equal to or above a third temperature of the melted chemical elements.

12. The method of claim 9, further comprising:
returning uncollimated atoms back to the melt chemical elements using the series of apertures.

13. The method of claim 9, wherein the series of apertures are shaped as slits.

14. The method of claim 9, further comprising:
rotating the oven to cause the melted chemical elements to be pressed against inner surfaces of the oven.

15. A space chemical separation apparatus comprising:
an oven having an enclosure configured to melt chemical elements and hold an associated vapor;
an oven egress comprising at least two apertures arranged in a series to create a collimated stream of atoms from the vapor;
a magnet configured to create a gradient magnetic field positioned to control the collimated stream of atoms, separating chemical elements therefrom; and
at least two containers configured to receive at least two different chemical elements after separation.

16. The apparatus of claim 15, further comprising:
a solar concentrator configured to concentrate solar energy and provide the concentrated solar energy to the oven to heat the oven to a first temperature sufficient to melt the chemical elements.

17. The apparatus of claim 16, wherein the solar concentrator is further configured to heat the at least two apertures to a second temperature that is substantially equal to or above a third temperature of the melted chemical elements.

18. The apparatus of claim 15, wherein the at least two apertures are further configured to return uncollimated atoms back to the melt chemical elements.

19. The apparatus of claim 15, wherein the at least two apertures are shaped as slits.

20. The apparatus of claim 15, wherein the oven is further configured to rotate to cause the melted chemical elements to be pressed against inner surfaces of the oven.

21. The apparatus of claim 15, further comprising:
a spray nozzle configured to form a stream of liquid drops from the melted chemical elements,
wherein the magnet is further configured to separate elements from the stream of liquid drops.
